(19) United States
(12) Patent Application Publication
(10) Pub. No.: US 2018/0239399 A1
(43) Pub. Date: Aug. 23, 2018

(54) COVER AND PORTABLE INFORMATION TERMINAL

(71) Applicant: LENOVO (SINGAPORE) PTE. LTD., Singapore (SG)

(72) Inventors: Kazuo Nakada, Yokohama-shi (JP); Tabito Miyamoto, Yokohama-shi (JP); Seita Horikoshi, Yokohama-shi (JP); Joseph David Plunkett, Morrisville, NC (US)

(73) Assignee: LENOVO (SINGAPORE) PTE. LTD., Singapore (SG)

(21) Appl. No.: 15/700,887

(22) Filed: Sep. 11, 2017

(30) Foreign Application Priority Data
Feb. 20, 2017 (JP) 2017029323
Jun. 19, 2017 (JP) 2017119635

(51) Int. Cl. G06F 1/16

(52) U.S. Cl. CPC G06F 1/1681; G06F 1/166

(57) ABSTRACT

The present disclosure provides a portable information terminal chassis cover, the chassis having one face on which a display part is disposed and the other face opposed to the one face, the cover having a function as a stand and capable of realizing the integrity at the entire other face. The cover includes: a movable part including a plate-like member on the other face, and partially covering the other face when the movable part is in contact with the chassis and being rotatable relative to the chassis; a sheet-like fixed part on the other face; a hinge part connecting the fixed part and the movable part, to support the movable part to the fixed part; and a surface member disposed closer to a surface than the movable part, the fixed part, and the hinge part are, and having a smooth surface without a gap over the entire other face.

### FIELD OF THE INVENTION

The present invention relates to covers and portable information terminals.

### BACKGROUND OF THE INVENTION

A portable information terminal, such as a tablet terminal (tablet computer), includes a chassis having a circuit board including a CPU and a memory built therein, and a touch panel disposed on the chassis. Such a portable information terminal allows a user to input information by touching the screen of the touch panel. In some cases, a user can view the contents on the display or can input data to the tablet terminal while holding the tablet terminal with a hand, and in other cases, a user can use the tablet terminal standing on a mount, such a desk or a table, using a stand.

The following Patent Document 1 discloses a technique of removing influences from magnetic force on a device making up an electronic apparatus while improving the stability of the electronic apparatus when the electronic apparatus is set up vertically.

[Patent Document 1] Japanese Patent Application Laid-Open No. 2016-201062

### SUMMARY OF THE INVENTION

Some of the stands for setting up a tablet terminal on the mount are always attached to a rear face of the chassis of the terminal to be openable/closeable via a hinge. When a user uses such a tablet terminal while holding it with a hand, the stand is closed to the chassis. When a user uses the tablet terminal while standing it on a mount, such as a desk, the stand is opened away from the chassis. The stand is like a flat plate in shape, for example. In one example, the stand extends over a substantially lower half of the rear face of the chassis. In another example, the stand has a U-letter shape made up of two parallel vertical members and one horizontal member connected to the lower ends of the two vertical members. In any case, the stand is connected to the rear face of the chassis at around a center of the chassis in the height direction.

Although the prior art stands are always attached to the rear face of the chassis, the stand is a separate member from the chassis. Therefore when the stand is closed, the boundary part between the chassis and an end of the stand has a linearly-shaped gap on the rear face of the tablet terminal. Such a gap may cause dust penetration into the rotating part. Since the chassis and the stand are separate members, it is difficult to manufacture a tablet terminal that is flush at the rear face when the stand is closed. Such a tablet terminal lacks the visual integrity at the rear face compared with a tablet terminal without a stand, and so does not have a sophisticated design.

In view of such a circumstance, the present invention aims to provide a cover of a chassis of a portable information terminal, the chassis having one face on which a display part is disposed and the other face opposed to the one face, the cover having a function as a stand and capable of realizing the integrity at the entire other face, and to provide such a portable information terminal.

A cover according to the first aspect of the present invention is a cover of a chassis of a portable information terminal, the chassis having one face and the other face opposed to the one face, the portable information terminal having a display part on the one face. The cover includes: a movable part including a plate-like member disposed on the other face, the movable part covering a part of the other face when the movable part is in contact with the chassis, and being rotatable relative to the chassis; a sheet-like fixed part fixed to the other face of the chassis; a hinge part connected to the fixed part and the movable part, the hinge part being configured to support the movable part to the fixed part; and a surface member disposed closer to a surface of the portable information terminal than the movable part, the fixed part, and the hinge part are to each other, the surface member having a smooth surface without a gap over the entire other face.

A cover according to the second aspect of the present invention is a cover of a chassis of a portable information terminal, the chassis having one face and the other face opposed to the one face, the portable information terminal having a display part on the one face. The cover includes: a movable part including a plate-like member disposed on the other face, the movable part covering a part of the other face when the movable part is in contact with the chassis, and being rotatable relative to the chassis; a hinge part connected to the chassis and the movable part, the hinge part being configured to support the movable part to the chassis; and a surface member disposed closer to a surface of the portable information terminal than the movable part and the hinge part are to one another, the surface member having a smooth surface without a gap over the entire other face.

A portable information terminal according to the third aspect of the present invention has one face and the other face opposed to the one face, and includes a display part disposed on the one face; and the cover according to any one of the first aspect or the second aspect, the cover being disposed on the other face.

According to the above-described aspects of the present invention, a cover of a chassis of a portable information terminal is provided, the chassis having one face on which a display part is disposed and the other face opposed to the one face. The cover has a function as a stand and can realize the integrity at the entire other face.

### BRIEF DESCRIPTION OF THE DRAWINGS

FIG. 1 is a front view of a tablet terminal according to one embodiment of the present invention.

FIG. 2 is a rear view of a tablet terminal according to one embodiment of the present invention.

FIG. 3 is a top view of a tablet terminal according to one embodiment of the present invention.

FIG. 4 is a bottom view of a tablet terminal according to one embodiment of the present invention.

FIG. 5 is a right side view of a tablet terminal according to one embodiment of the present invention.

FIG. 6 is a left side view of a tablet terminal according to one embodiment of the present invention.

FIG. 7 is a perspective view of a tablet terminal according to one embodiment of the present invention viewed from the front face, showing the state when the cover is closed.

FIG. 8 is a perspective view of a tablet terminal according to one embodiment of the present invention viewed from the rear face, showing the state when the cover is closed.

FIG. 9 is a perspective view of a tablet terminal according to one embodiment of the present invention viewed from the front face, showing the state when the cover is opened.

FIG. 10 is a perspective view of a tablet terminal according to one embodiment of the present invention viewed from the rear face, showing the state when the cover is opened.

FIG. 11 is a rear view of a tablet terminal according to one embodiment of the present invention, showing the cover with gray dots.

FIG. 12 is a top view of a tablet terminal according to one embodiment of the present invention, showing the cover with gray dots.

FIG. 13 is a bottom view of a tablet terminal according to one embodiment of the present invention, showing the cover with gray dots.

FIG. 14 is a right side view of a tablet terminal according to one embodiment of the present invention, showing the cover with gray dots.

FIG. 15 is a left side view of a tablet terminal according to one embodiment of the present invention, showing the cover with gray dots.

FIG. 16 is a perspective view of a tablet terminal according to one embodiment of the present invention viewed from the front face, showing the cover with gray dots and the state when the cover is closed.

FIG. 17 is a perspective view of a tablet terminal according to one embodiment of the present invention viewed from the rear face, showing the cover with gray dots and the state when the cover is closed.

FIG. 18 is a perspective view of a tablet terminal according to one embodiment of the present invention viewed from the front face, showing the cover with gray dots and the state when the cover is opened.

FIG. 19 is a perspective view of a tablet terminal according to one embodiment of the present invention viewed from the rear face, showing the cover with gray dots and the state when the cover is opened.

FIG. 20 is a longitudinal cross-sectional view of a tablet terminal according to one embodiment of the present invention, showing the state when the cover is closed.

FIG. 21 is a rear view of a tablet terminal according to one embodiment of the present invention, showing the movable plate and the fixed plate after the surface member is removed.

FIG. 22 is a longitudinal cross-sectional view of a tablet terminal according to one embodiment of the present invention, showing the state when the cover is opened.

FIG. 23 is a side view of one example of a hinge applied to a tablet terminal according to one embodiment of the present invention.

FIG. 24 is a side view of one example of a hinge applied to a tablet terminal according to one embodiment of the present invention.

FIG. 25 is a longitudinal cross-sectional view of another example of a tablet terminal according to one embodiment of the present invention, showing the state when the cover is closed.

FIG. 26 is a longitudinal cross-sectional view of another example of a tablet terminal according to one embodiment of the present invention, showing the state when the cover is opened.

FIG. 27 is a cross-sectional view of a tablet terminal according to one embodiment of the present invention.

### DETAILED DESCRIPTION OF THE INVENTION

Referring to the drawings, the following describes a tablet terminal 1 according to one embodiment of the present invention.

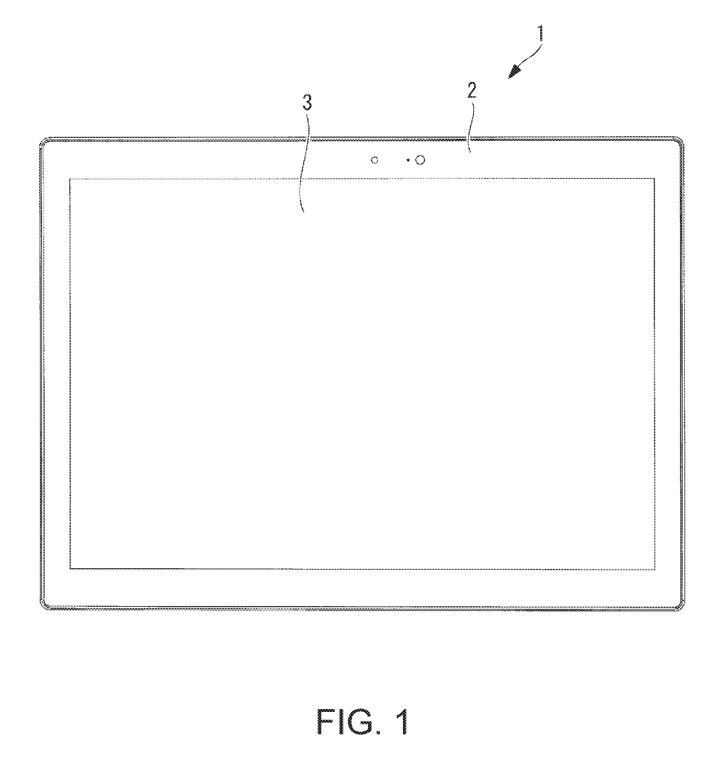

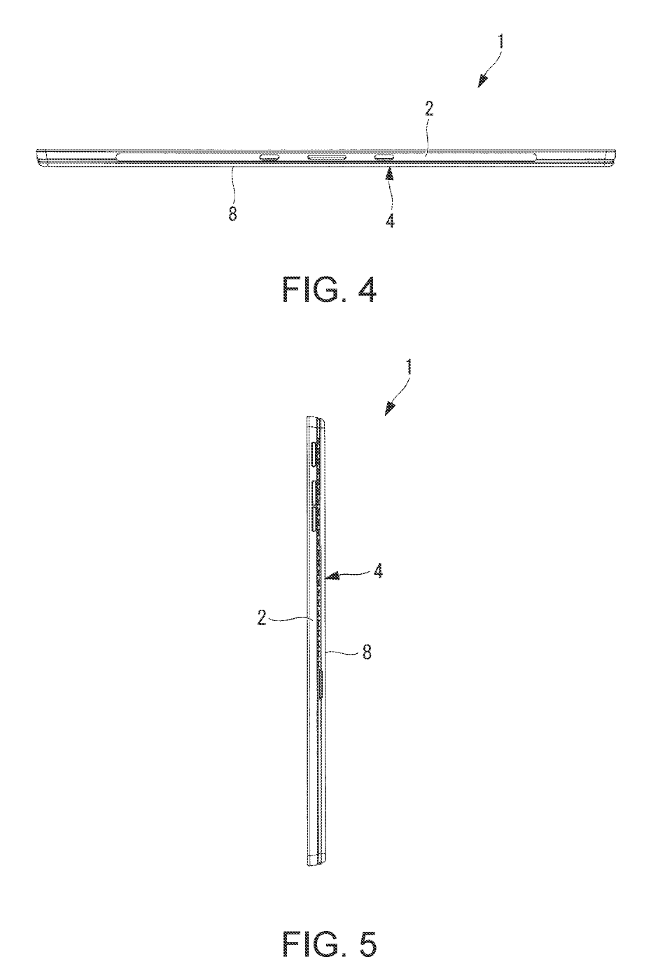

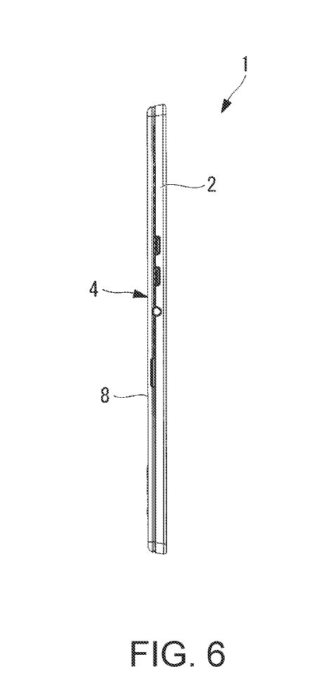

The tablet terminal 1 is one example of the portable information terminal. As shown in FIGS. 1 to 10, the tablet terminal includes a panel-like chassis 2, and the chassis 2 includes a display module 3. The chassis 2 accommodates a circuit board coming with a CPU and a memory, and a power supply, such as a battery. The tablet terminal 1 includes a controller implemented by the CPU or the like.

The display module 3 on one face of the chassis 2 includes a liquid crystal display, for example, to display an image. The display of the display module 3 to display an image is not limited to a liquid crystal display, which may be an organic EL display, for example. The display module 3 includes a touch panel configured to detect a contact on the display screen from the outside with a finger or the like, and enable inputting of information.

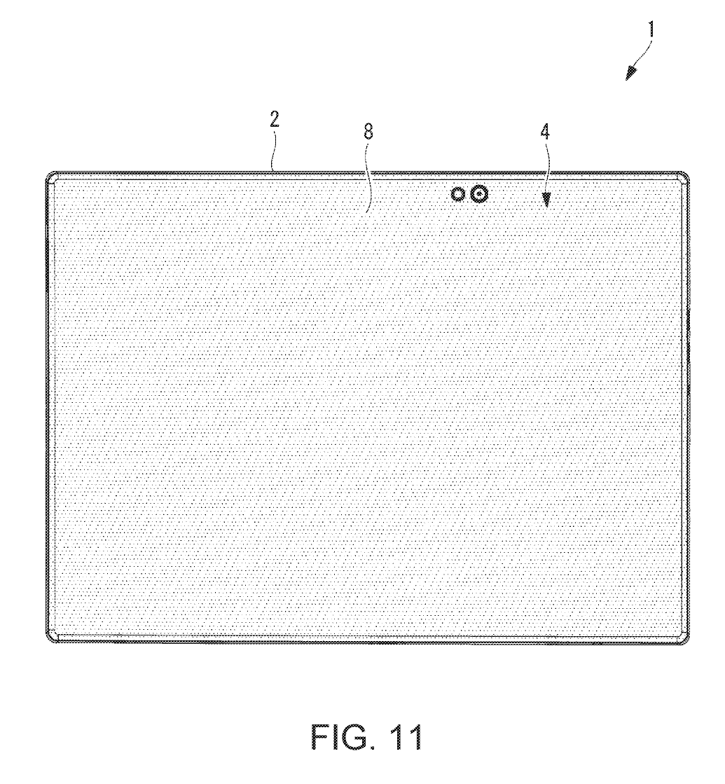

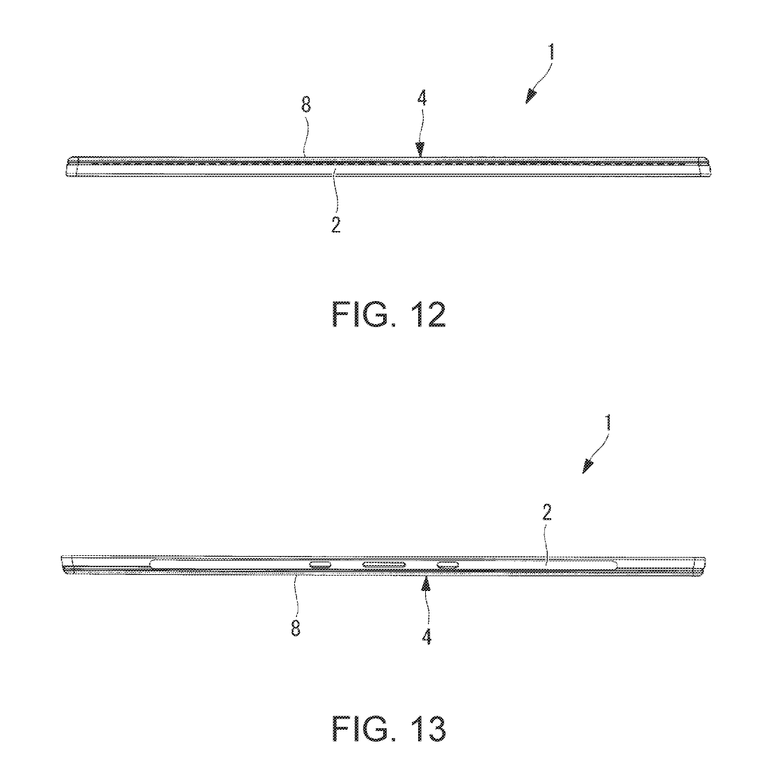

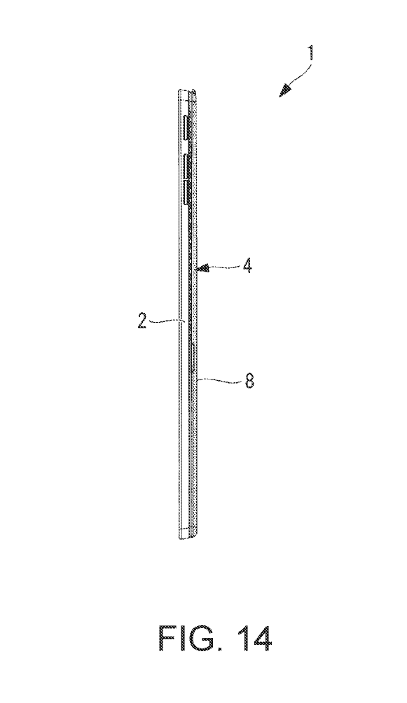

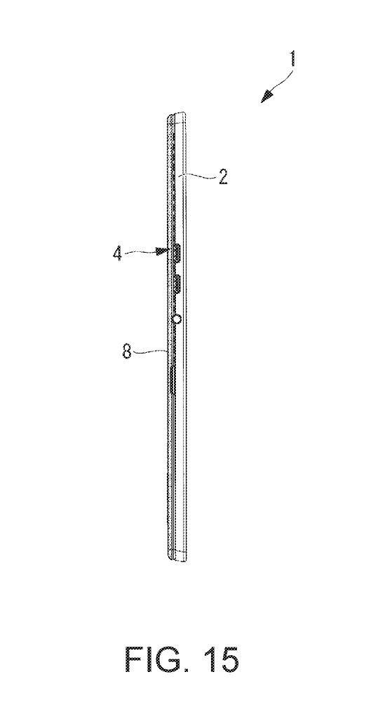

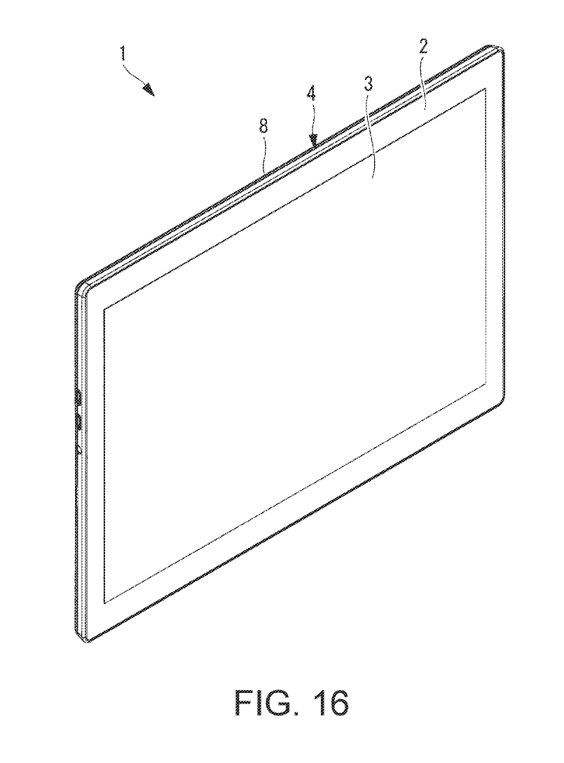

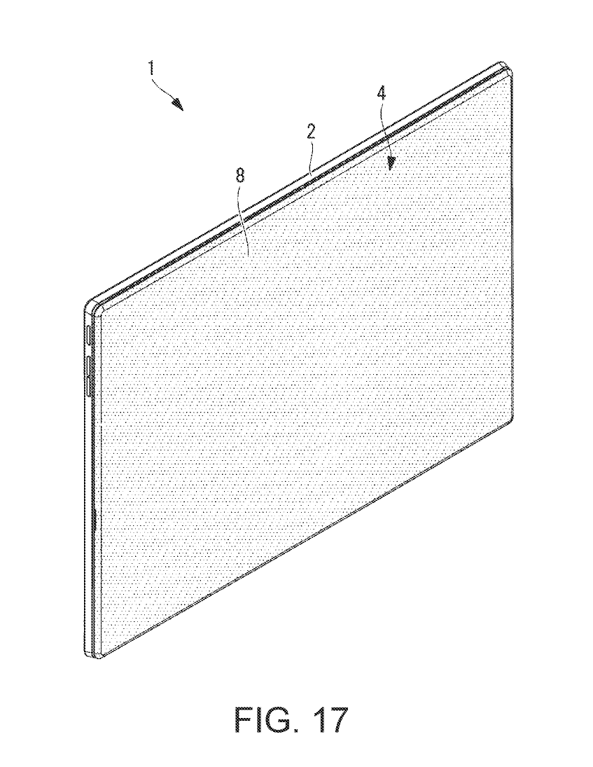

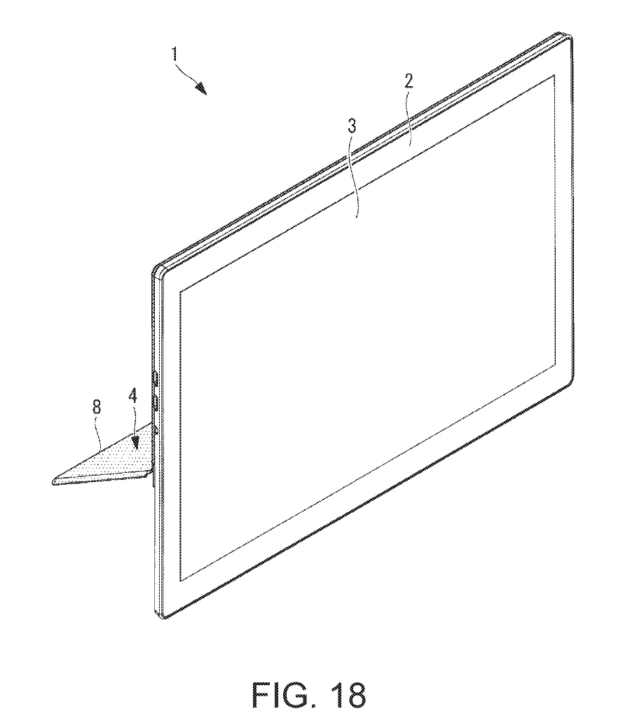

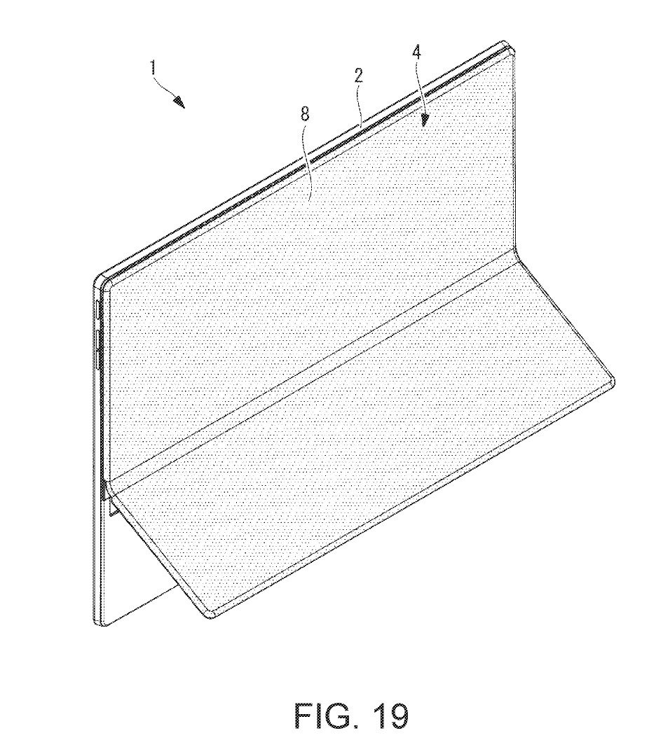

The chassis 2 of the tablet terminal 1 includes a cover 4, and the cover is disposed on the other face (rear face) opposed to one face (front face) of the chassis 2 having the display module 3. As shown in FIGS. 11 to 19, the cover 4 covers the entire rear face of the chassis 2. FIGS. 11 to 19 show the cover 4 with gray dots.

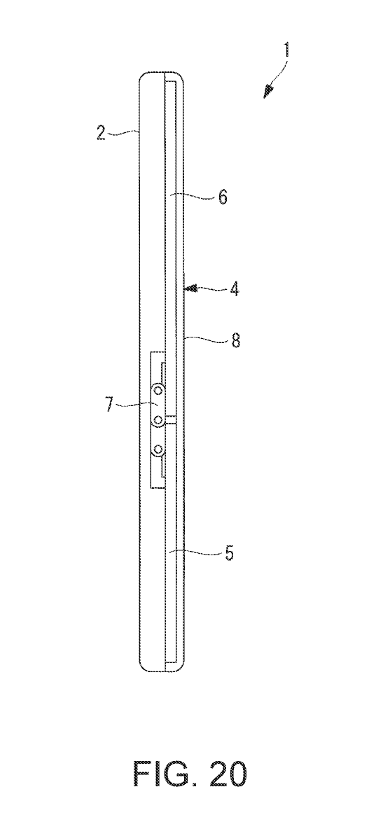

As shown in FIGS. 20 to 22, the cover 4 in one example includes: a movable plate 5 having a function as a stand when it is opened; a fixed plate 6 attached to the chassis 2; a hinge 7 connected to the movable plate 5 and the fixed plate 6; and a surface member 8 having a smooth surface. The movable plate 5, the fixed plate 6 and the hinge 7 are one example of a movable part, a fixed part and a hinge part, respectively.

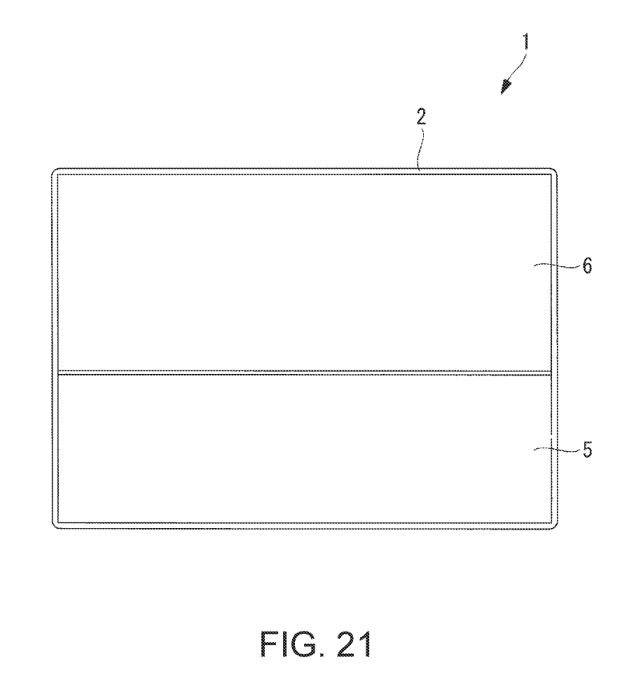

As shown in FIG. 21, each of the movable plate 5 and the fixed plate 6 is one flat-plate like member made of metal. The movable plate 5 and the fixed plate 6 are rectangular, and are disposed adjacent to each other. The shape obtained by combining the movable plate 5 and the fixed plate 6 is substantially the same as the shape of the rear face of the chassis 2.

The movable plate 5 and the fixed plate 6 are adjacent at a position around a center of the chassis 2 in the short-side direction. The long sides of the movable plate 5 and of the fixed plate 6 have a length substantially the same as that of the long side of the chassis 2. The outer long sides of the movable plate 5 and of the fixed plate 6 are along the long-side ends of the chassis 2.

The short side of the movable plate 5 has a length that is about half or a half or less of the short side of the chassis 2. The short side of the fixed plate 6 has a length such that the length added to the length of the short side of the movable plate 5 equals the length of the short side of the chassis 2. The two opposed short sides of the movable plate 5 and the two opposed short sides of the fixed plate 6 are along the short sides of the chassis 2.

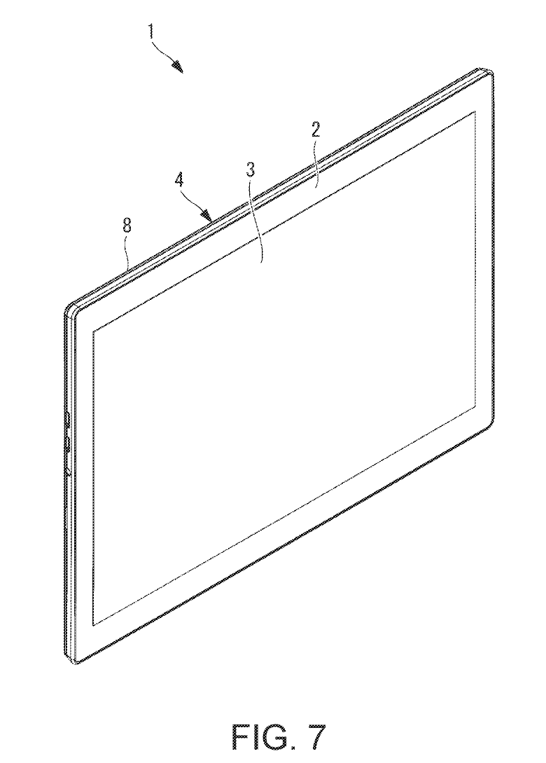

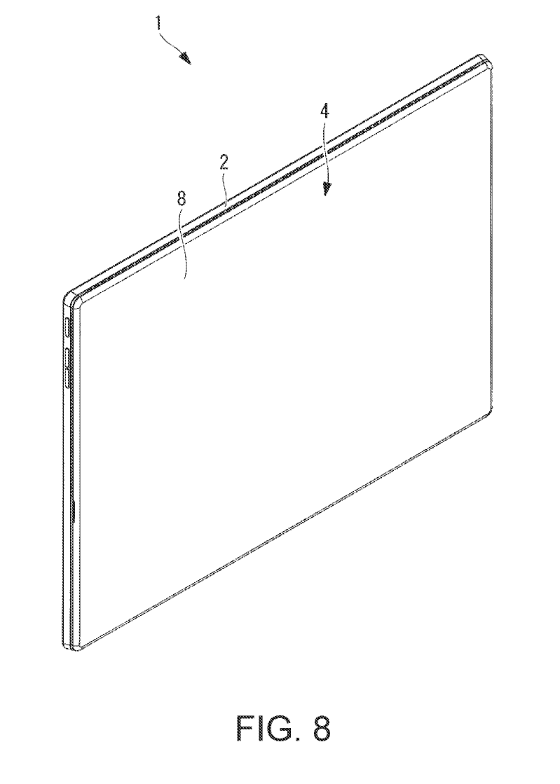

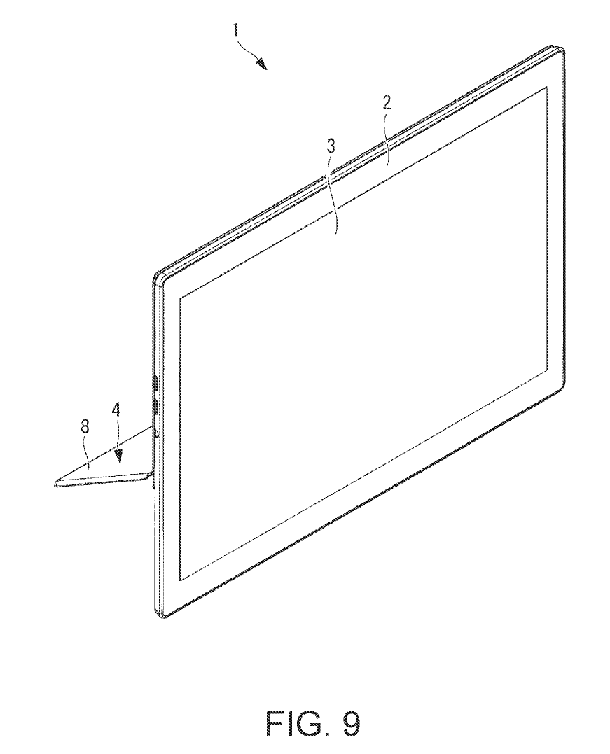

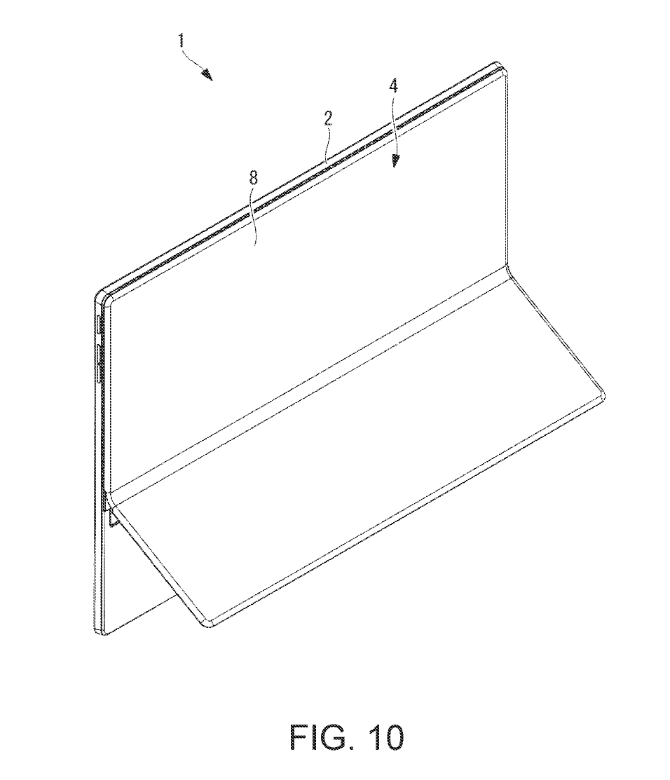

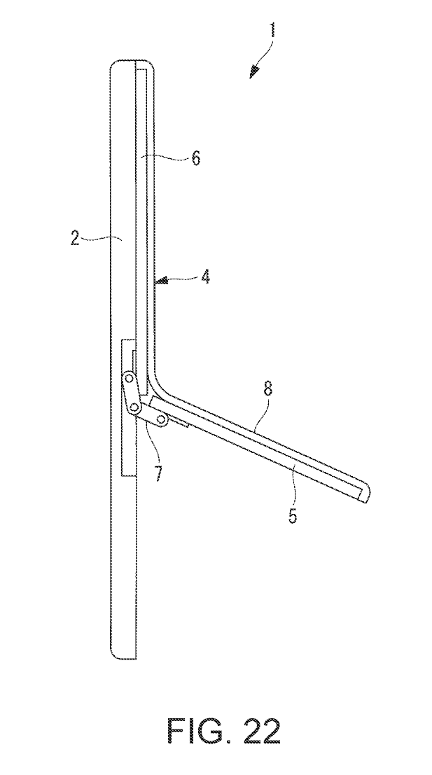

As shown in FIGS. 20 and 22, the movable plate 5 is rotatable so as to be opened or closed relative to the chassis 2 via the hinge 7. The movable plate 5 rotates around a part close to its long-side end that is adjacent to the fixed plate 6. As shown in FIG. 20, when the movable plate 5 is in contact with the chassis 2, i.e., when it is closed, the movable plate covers a part of the rear face of the chassis 2. FIGS. 7 and 8 are perspective views of the tablet terminal 1 when the cover 4 is closed. As shown in FIG. 22, when the movable plate 5 is away from the chassis 2, i.e., when it is opened, the movable plate can be used as a stand (a leg) to support the tablet terminal 1. FIGS. 9 and 10 are perspective views of the tablet terminal 1 when the cover 4 is opened.

The fixed plate 6 is fixed to the rear face of the chassis 2. The fixed plate 6 and the chassis 2 are mutually fixed with a screw or adhesive, for example.

As shown in FIGS. 20 and 22, the hinge 7 has one side connected to the movable plate 5 and the other side connected to the fixed plate 6. The hinge 7 supports the movable plate 5 to the fixed plate 6. Since the fixed plate 6 is fixed to the chassis 2, the movable plate 5 is supported to the chassis 2 via the hinge 7 and the fixed plate 6.

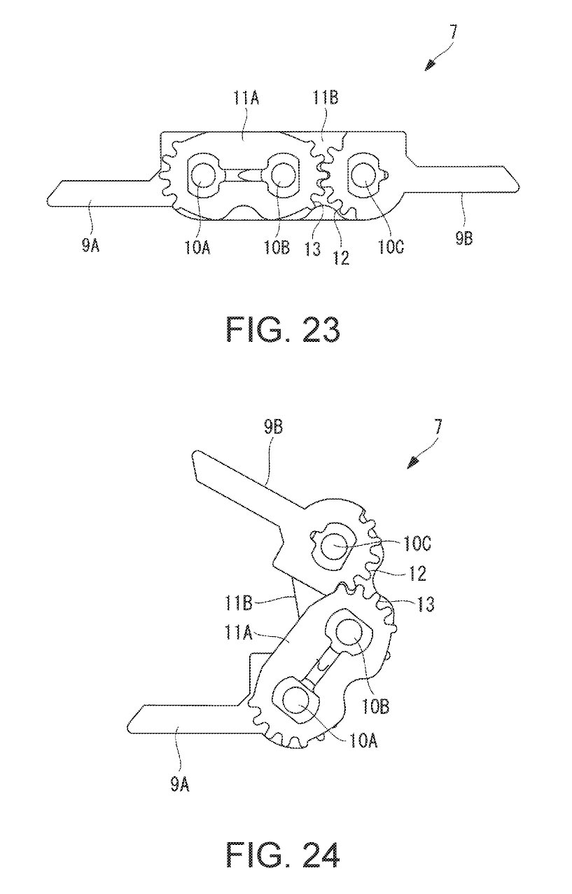

The hinge 7 may have one rotary shaft. Alternatively as shown in FIGS. 23 and 24, the hinge may be a multiple-shaft hinge including a plurality of rotary shafts 10A, 10B and 10C that are parallel to each other. In the case of a hinge having one rotary shaft, when the movable plate 5 rotates, a distance from the fixed plate 6 to the movable plate 5 is short. This means a small radius of curvature is at the bending part, and easily causes a sharply bending state of the surface member 8. On the contrary, in the case of a multiple-shaft hinge as the hinge 7 as shown in FIGS. 23 and 24, when the movable plate 5 rotates, the movable plate 5 can be away from the fixed plate 6. This allows the surface member 8 to bend gradually compared with the case of a hinge having one rotary shaft (see FIG. 22). This can reduce the risk of a wrinkle resulting from the bending of the surface member 8 because the surface member is hardly plastic-deformed after repeated opening and closing of the movable plate 5.

The hinge 7 as the multiple-shaft hinge includes connecting parts 9A, 9B, rotary shafts 10A, 10B, 10C and coupling plates 11A, 11B, for example. The connecting part 9A is connected to the fixed plate 6, for example, and the connecting part 9B is connected to the movable plate 5, for example. The rotary shaft 10A is disposed so as to penetrate through the connecting part 9A and the coupling plate 11A. The rotary shaft 10B is disposed so as to penetrate through the coupling plate 11A and the coupling plate 11B. The rotary shaft 10C is disposed so as to penetrate through the coupling plate 11B and the connecting part 9B. As shown in FIGS. 23 and 24, the connecting part 9B and the coupling plate 11A mate with each other via their gears 12 and 13 on the lateral end faces. Although not illustrated, similarly to the relationship between the connecting part 9B and the coupling plate 11A, the connecting part 9A and the coupling plate 11B also mate with each other via their gears and on the lateral end faces.

When the movable plate 5 rotates relative to the fixed plate 6, the connecting part 9A and the coupling plate 11A mutually rotate about the rotary shaft 10A, the coupling plate 11A and the coupling plate 11B mutually rotate about the rotary shaft 10B, and the coupling plate 11B and the connecting part 9B mutually rotate about the rotary shaft 10C. As shown in FIG. 22, this results in a gentle bending shape at the bending part of the surface member 8 between the movable plate 5 and the fixed plate 6.

As shown in FIGS. 20 and 22, the surface member 8 is disposed closer to the surface than the movable plate 5, the fixed plate 6 and the hinge 7 are to each other, and has a smooth surface without a gap over the entire rear face of the chassis 2 as shown in FIGS. 1 to 19. The surface member 8 may be made of synthetic resin, rubber, leather, or cloth, for example. The surface member 8 is disposed to cover the movable plate 5 and the fixed plate 6, and is joined to the movable plate 5 and the fixed plate 6 with adhesive.

The surface member 8 can block the gap defined at the boundary part between the movable plate 5 and the fixed plate 6, and so can reduce dust penetration into the rotary part. Since the surface member 8 has a certain thickness, it can accommodate a difference in thickness between the movable plate 5 and the fixed plate 6. Therefore, the tablet terminal manufactured can have the rear face of a chassis 2 that is flush without a difference in thickness. This allows the tablet terminal 1 to be placed stably when the rear face of the chassis 2 of the tablet terminal is placed on the mount, such as a desk, without opening the movable plate 5.

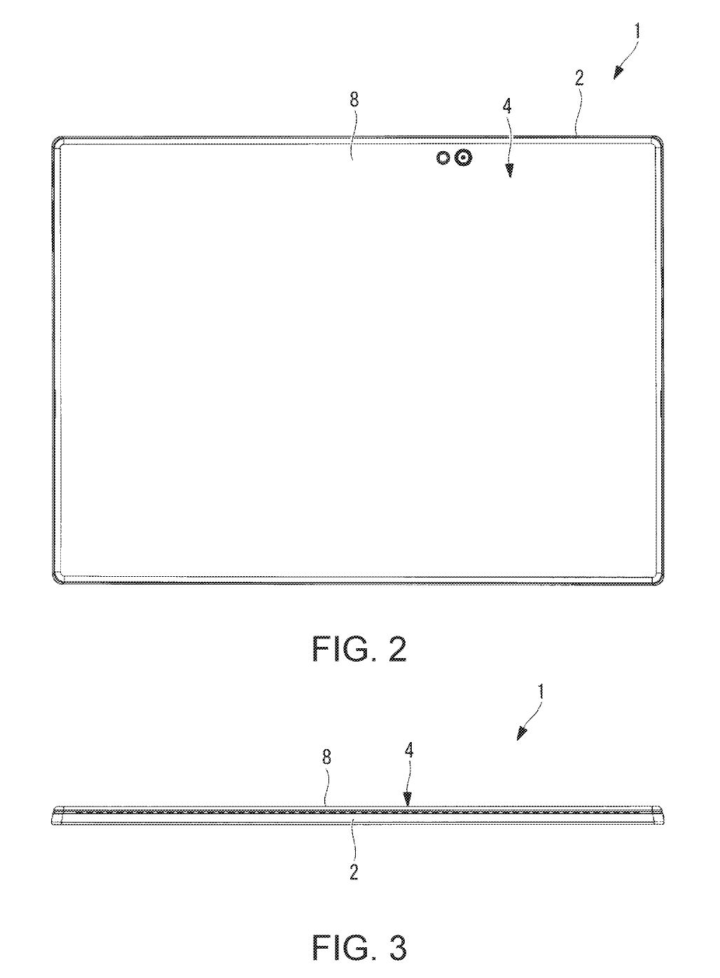

Further, as shown in FIGS. 2 and 8, for example, similarly to a tablet terminal without a stand, the visual integrity of the rear face of the chassis 2 can be achieved, and so the tablet terminal can have a sophisticated design. The surface member 8 may be made of a non-slip material, or the surface member 8 may be subjected to a surface treatment for non-slipperiness. This can prevent the slipping of the tablet terminal 1 on the mount, such as a desk, when the rear face of the chassis 2 is placed on the mount.

Preferably, the surface member 8 is made of a stretch material. This allows the surface member 8 to stretch while following the motion of the movable plate 5. For example, the surface member 8 may shrink when the movable plate 5 is opened away from the chassis 2 as shown in FIG. 20, and the surface member 8 may expand when the movable plate 5 comes in contact with the chassis 2 as shown in FIG. 22. In the case of a surface member 8 without such stretch properties, the surface member 8 cannot shrink and generates a wrinkle easily when the movable plate 5 is opened away from the chassis 2. On the contrary, the surface member 8 having such stretch properties can reduce such a wrinkle.

As shown in FIGS. 20 and 22, the surface member 8 may have an end that covers the lateral ends of the movable plate 5 and the fixed plate 6. For instance, the surface member 8 may have a round face near the end. This can prevent the surface member 8 from coming off from the movable plate 5 and the fixed plate 6. Such a surface member can exert a function of preventing the slipping as well when the lateral end face of the tablet terminal 1 comes into contact with another face.

When the above-described cover 4 is manufactured, the movable plate 5, the fixed plate 6, the hinge 7, and the surface member 8 are firstly assembled so as to be one assembled body (assembly). Then after such a cover 4 as one assembly is manufactured, the fixed plate 6 of the cover 4 is attached to the chassis 2. In this way, since the cover 4 can be handled as an assembly, the rear-face side member of the tablet terminal 1 having a function as a stand can be easily formed and assembled.

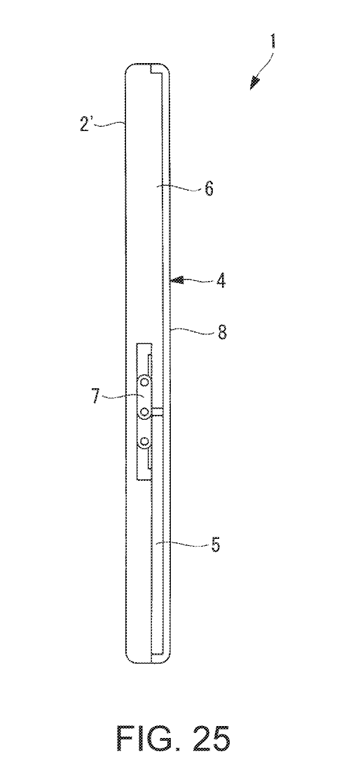

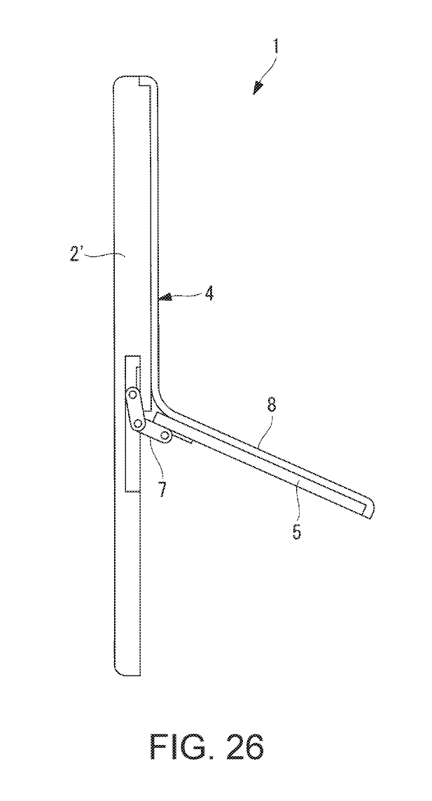

The cover 4 of the present invention does not necessarily have to include the fixed plate 6. As shown in FIGS. 25 and 26, one side of the hinge 7 may be directly fixed to a chassis 2′, and the movable plate 5 may be supported to the chassis 2′ via the hinge 7. In this case, the rear face of the chassis 2′ has a shape at a part thereof that can be alternative to the fixed plate 6 shown in FIGS. 20 and 22. As shown in FIG. 25, the chassis 2′ does not have a difference in thickness between the rear face of the chassis 2′ and the movable plate 5 when the movable plate 5 is closed. The surface member 8 is disposed closer to the surface than the chassis 2′, the movable plate 5, and the hinge 7 are to each other, and has a smooth surface without a gap over the entire rear face of the chassis 2′. The surface member 8 is disposed to cover the movable plate 5 and the chassis 2′. In this case also, the surface member 8 can block the gap defined at the boundary part between the movable plate 5 and the chassis 2′, and so can reduce dust penetration into the rotary part.

In this modified example, the movable plate 5 and the hinge 7 are attached to the rear face of the chassis 2′, and then the surface member 8 may be joined to the rear face of the chassis 2′ and the movable plate 5 with adhesive or the like, whereby the rear-side member of the tablet terminal 1 having a function as a stand can be assembled.

As stated above, according to the present embodiment, the rear-side member of the tablet terminal 1 having a function as a stand can have a design with visual integrity as in a tablet terminal without a stand. Further, the surface member 8 blocks the gap between the chassis 2 and the movable plate 5, and so can reduce dust penetration into the movable part and can avoid interference with the rotation of the movable plate 5.

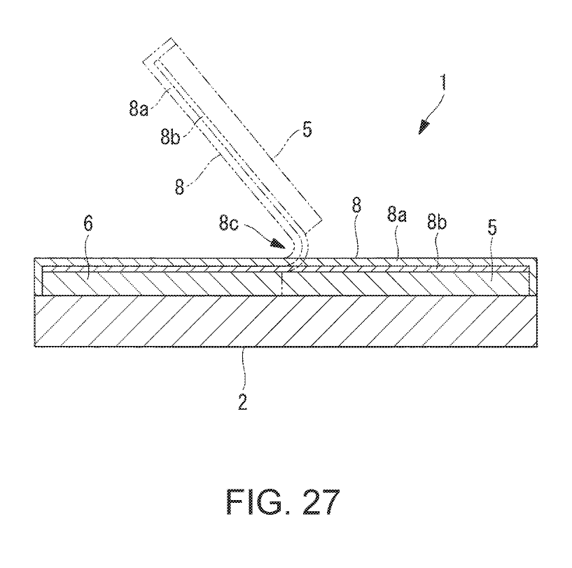

FIG. 27 shows one example of the cross section of the tablet terminal 1. As shown in this drawing, the surface member 8 includes a plurality of layers. As shown in this drawing, the surface member 8 includes an elastomer layer 8a including a silicon rubber (elastomer material) and a metal layer 8b made of stainless steel (metal). The elastomer layer 8a is a plate-like member having an outer shape of the surface member 8. The elastomer layer 8a covers the entire surface (upper side in this drawing) of the metal layer 8b. The elastomer layer 8a covers the metal layer 8b as well as the peripheral ends of the movable plate 5 and the fixed plate 6. This drawing omits the hinge 7 shown in FIG. 20 or the like.

The elastomer layer 8a has a thickness of 200 μm or more and 300 μm or less, for example. The metal layer 8b has a thickness of 30 μm or more and 50 μm or less, for example.

Such a metal layer 8b gives strength to a bending part 8c against the bending that occurs when the movable plate 5 is rotated relative to the fixed plate 6. This can make the elastomer layer 8a covering the metal layer 8b thinner, and so can minimize (preferably does not generate) a wrinkle generated in the surface of the elastomer layer 8a when the surface member 8 is bent.

The elastomer layer 8a may be made of other elastomer materials, instead of silicon rubber. The metal layer 8b may be made of other metal materials, instead of stainless steel.

The metal layer 8b is disposed across the entire surface member 8 in the above example. Instead, the metal layer may be partially disposed as long as it is disposed at least at an area including the bending part 8c.

1. A portable information terminal having one face and other face opposed to the one face, comprising:
a display part disposed on the one face; and
a cover disposed on the other face, the cover including:
a movable part including a plate-like member disposed on the other face, the movable part covering a part of the other face when the movable part is in contact with the chassis, and being rotatable relative to the chassis;
a hinge part connected to the chassis and the movable part, the hinge part being configured to support the movable part to the chassis; and
a surface member disposed closer to a surface of the portable information terminal than the movable part and the hinge part are to each other, the surface member having a smooth surface without a gap over the entire other face.

2. The portable information terminal according to claim 1, wherein the surface member includes a stretch material.

3. The portable information terminal according to claim 1, wherein the hinge part includes a multiple-shaft hinge having a plurality of rotary shafts that are disposed parallel to each other.

4. The portable information terminal according to claim 1, wherein the surface member includes: an elastomer layer disposed close to a surface of the surface member and including an elastomer material; and a metal layer disposed close to a rear face of the surface member and including a metal material.

5. A cover of a chassis of a portable information terminal, the chassis having one face and an other face opposed to the one face, the portable information terminal having a display part on the one face, comprising:
a movable part including a plate-like member disposed on the other face, the movable part covering a part of the other face when the movable part is in contact with the chassis, and being rotatable relative to the chassis;
a sheet-like fixed part fixed to the other face of the chassis;
a hinge part connected to the fixed part and the movable part, the hinge part being configured to support the movable part to the fixed part; and
a surface member disposed closer to a surface of the portable information terminal than the movable part, the fixed part, and the hinge part are to each other, the surface member having a smooth surface without a gap over the entire other face.

6. The cover according to claim 5, wherein the surface member includes a stretch material.

7. The cover according to claim 5, wherein the hinge part includes a multiple-shaft hinge having a plurality of rotary shafts that are disposed parallel to each other.

8. The cover according to claim 5, wherein the surface member includes: an elastomer layer disposed close to a surface of the surface member and including an elastomer material; and a metal layer disposed close to a rear face of the surface member and including a metal material.

9. A portable information terminal having one face and other face opposed to the one face, comprising:
a display part disposed on the one face; and
a cover disposed on the other face, the cover including:
a movable part including a plate-like member disposed on the other face, the movable part covering a part of the other face when the movable part is in contact with the chassis, and being rotatable relative to the chassis;
a sheet-like fixed part fixed to the other face of the chassis;
a hinge part connected to the fixed part and the movable part, the hinge part being configured to support the movable part to the fixed part; and
a surface member disposed closer to a surface of the portable information terminal than the movable part, the fixed part, and the hinge part are to each other, the surface member having a smooth surface without a gap over the entire other face.
